(19) United States
(12) Patent Application Publication
(10) Pub. No.: US 2006/0267324 A1
(43) Pub. Date: Nov. 30, 2006

(54) Gas bag

(75) Inventors: Thomas Britz, Bessenbach (DE); Marcus Magoley, Aschaffenburg (DE); Lothar Orth, Aschaffenburg (DE); Dominik Schuetz, Waldaschaff (DE); Andreas Krist, Grosswallstadt (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/438,596

(22) Filed: May 22, 2006

(30) Foreign Application Priority Data
May 24, 2005 (DE) 20 2005 008 147.7

(51) Int. Cl. B60R 21/23; B60R 21/235

(52) U.S. Cl. 280/743.1

(57) ABSTRACT

A gas bag (1) for use in a vehicle occupant restraint device comprises a wall part (3) of an uncoated fabric and a heat protection device (11) applied onto a section of the wall part (3). The heat protection device (11) is formed from at least one layer of a further uncoated fabric (13) glued to the wall part (3) using a flame-retardant adhesive (15).

### TECHNICAL FIELD OF THE INVENTION

The invention relates to a gas bag for use in a vehicle occupant restraint system.

### BACKGROUND OF THE INVENTION

Gas bag fabrics generally consist of polyamides, for example polyamide 6 or polyamide 6.6. The fabrics are usually provided with a silicone coating for protection from the hot gases and particles released upon activation of a gas generator and impinging onto the gas bag fabric. However, these coated fabrics have a high weight per unit area and can not be folded well. Therefore the gas bags for vehicle occupant restraint systems are nowadays increasingly being produced from uncoated fabrics. In the case of these gas bags, however, the wall parts which are under high thermal stress, like the regions of the gas bag fabric adjoining the inflation opening, must be protected by special measures from damage by hot gases and particles.

DE 43 35 809 A1 describes a gas bag with an inflation opening arranged at the rearward end of the gas bag, to receive a gas generator and also a heat-resistant covering which consists of a non-inflammable cloth and is sewn to the peripheral rim of the inflation opening. The covering may, in particular, be a cloth of silicone rubber.

### SUMMARY OF THE INVENTION

It is therefore an object of the invention to provide a gas bag in which damage to the gas bag fabric by hot gases and particles is reliably prevented with the aid of simple and favourably priced measures.

The gas bag according to the invention is provided for use in a vehicle occupant restraint arrangement and comprises a wall part made of an uncoated fabric and a heat protection device applied onto the wall part. The heat protection device is formed from at least one layer of a further uncoated fabric and is glued to the wall part using a flame-retardant adhesive.

The advantage of the invention therefore lies in that the adhesive itself is used as flame protection. Therefore no fabric has to be used which is protected by coating or other technical measures against damage by the impinging hot gases or particles. As the same uncoated material can be used for the gas bag fabric and the fabric of the heat protection device, the reusability of the fabric material is also improved. The uncoated fabrics are, in addition, more favourably priced and can be folded more easily owing to their better flexibility.

The flame-retardant adhesive preferably comprises a polymer composition based on polyurethane. However, other known adhesives can also be used which are compatible with the polyamides usually used for the gas bag fabrics.

The adhesive may be equipped so as to be flame-retardant through the admixing of known flame protection agents, such as for example organic halogen compounds or phosphorus compounds.

Particularly preferably, however, the flame-retardant adhesive comprises a polymer matrix, for example of polyurethane, with exfoliated stratified silicate (phyllosilicate) particles distributed therein as the flame protection agent, the exfoliated stratified silicate particles having a thickness of 0.5 to 2 nm and a surface diameter of up to 10 μm. The compounding of the phyllosilicates into the polymer matrix of the adhesive to form platelet-shaped exfoliated stratified silicate particles, alongside an increased mechanical strength and resistance to temperature change, also brings about a distinct improvement in the flame-retardant characteristics and the barrier effect with respect to gases and liquids. The inorganic stratified silicate particles are, in addition, non-poisonous and are therefore toxicologically harmless.

The exfoliated stratified silicate particles are preferably present in a proportion of 0.5 to 10 parts by weight, particularly preferably from 1 to 6 parts by weight per 100 parts by weight of the polymer matrix of the flame-retardant adhesive. Natural or synthetic two-layer or three-layer silicates can be used as stratified silicates or phyllosilicates, which are suitable for ion exchange. Montmorrilonite, saponite, beidelite, nontronite, sauconite, stevensonite and hectorite, bentonite, vermiculite, halloysite, kaolin, calcium methasilicate or smectite and also chlorinated or fluorinated synthetic derivatives of these minerals, such as fluorosmectite, are typical representatives of phyllosilicates. The stratified silicates preferably have an ion exchange capacity of at least 20 to 200 meq/100 g (milliequivalent in relation to 100 g solids content). The ion exchange capacity indicates the concentration of ions which are able to be substituted through solutions of neutral salts from the stratified silicate surface by a stoichiometric ion exchange mechanism.

The surface of the stratified silicate particles can be rendered hydrophobic by ion exchange with organic onium compounds, such as for example ammonium compounds (NR₄⁺), phosphonium compounds (PR₄⁺), oxonium compounds (R₃O⁺), diazonium compounds RN₂⁺, arsonium compounds (AsR₄⁺) and sulphonium compounds (R₃S⁺). The radicals R of the organic onium compound may be identical or different and are selected from the group consisting of hydrogen, substituted and unsubstituted, saturated and unsaturated alkyl groups with 1 to 40 carbon atoms with or without branching and substituted and unsubstituted aryl groups and benzyl groups, at least one organic radical R being a saturated or unsaturated alkyl group, substituted with functional groups or unsubstituted, having at least 6 carbon atoms.

The quaternary ammonium compounds which are derived from lactams or ω amino acids and their derivatives are preferred.

### BRIEF DESCRIPTION OF THE DRAWINGS

FIG. 1 shows a schematic elevation of the rear of a gas bag according to the invention; and

FIG. 2 shows a schematic sectional view along line II-II in FIG. 1.

### DESCRIPTION OF A PREFERRED EMBODIMENT OF THE INVENTION

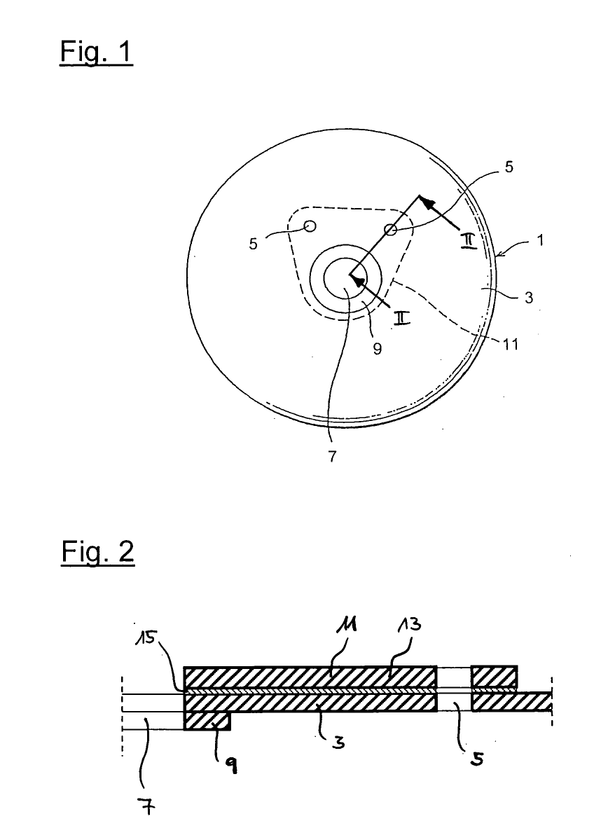

In the embodiment shown in FIGS. 1 and 2, the gas bag 1 comprises a substantially disc-shaped wall part 3 on the rear side, and also a further substantially disc-shaped wall part which is not illustrated in the figure and forms the front side of the gas bag 1. The wall part on the front side and the wall part 3 on the rear side are connected with each other at their peripheral edges by sewing or by weaving in one piece. Two pressure equalization openings 5, through which the gas blown into the gas bag 1 in the case of an impact of the vehicle occupant onto the wall part on the front side can escape in a defined manner, are arranged in addition in the wall part 3 on the rear side.

The wall part 3 on the rear side has in addition an inflation opening 7 in which a gas generator (not shown) is held in a known manner. A holding ring 9 which serves for fastening the gas bag 1 or the rear wall part 3 to the gas generator is arranged around the inflation opening. A heat protection device 11 is glued onto a section of the rear wall part 3 of the gas bag 1 adjoining the inflation opening 7. In the embodiment shown here, the heat protection device 11 is glued onto the inner surface of the wall part 3 which is directly exposed to the hot gases and particles flowing out from the gas generator. The heat protection device can, however, also be glued onto the outer surface of the wall part 3 on the vehicle side. In addition, further wall sections of the gas bag 1 can be provided with a heat protection device, such as for example the section of the wall part on the front side lying opposite the inflation opening 7.

According to the invention, the heat protection device 11 is formed from an uncoated fabric 13 which preferably consists of polyamide, like the wall parts of the gas bag. In the embodiment shown in FIGS. 1 and 2, the heat protection device 11 extends from the inflation opening 7 up to the pressure equalization openings 5. The shape and extent of the heat protection device 11 are able to be freely selected, however, and can be adapted by a specialist in the art to the requirements resulting from the performance profile of the gas generator. The heat protection device 11 may, in addition, be formed from one or more layers of the uncoated fabric 13.

According to the invention, a flame-retardant adhesive 15 which itself provides the necessary flame protection and protects the fabric of the wall part 3 reliably from damage by the hot gases and particles emerging from the gas generator, is used for gluing the fabric layers 13 of the heat protection device 11 to the wall part 3 of the gas bag 1. The flame-retardant adhesive 15 preferably comprises a polymer matrix of a polyurethane composition, in which platelet-shaped exfoliated stratified silicate particles with a thickness of 0.5 to 2 nm and a surface diameter of up to 10 μm are distributed. By the compounding of stratified silicates into the polymer matrix under polymer-specific process conditions, before, during or after the polymerization of the corresponding monomers, for example in a double worm melt extruder at increased temperature, the stratified silicates are exfoliated such that a substantially homogeneous distribution of the particles occurs in the polymer matrix. A suitable adhesive 15 may for example be obtained by compounding 3 parts by weight of a stratified silicate which has been rendered hydrophobic (bentonite, rendered hydrophobic with dimethyldioctadecyl ammonium chloride; surface diameter >1 μm, layer thickness 0.5 to 2 nm) in 100 parts by weight of a conventional polyurethane adhesive. The polyurethane adhesive which has been modified in this way has flame-retardant characteristics and, furthermore, shows an improved barrier effect with respect to gases and liquids and also an improved mechanical load bearing capacity and resistance to temperature change.

The gas bag 1 which is obtainable by gluing the heat protection device 11 to the wall part 3 using the flame-retardant adhesive, is reliably protected from damage by the hot gases and particles impinging onto the heat protection device 11. In addition, the gas bag 1 is able to be folded easily and is also able to be produced at a favourable cost owing to the saving on coating material.

The gas bag 1 described above is provided in particular for use in a gas bag module for the driver's side of a vehicle occupant restraint system. However, the invention is not limited to this use; it can also be applied to other gas bag configurations, for example to a passenger gas bag or to a head/side gas bag.

1. A gas bag (1) for use in a vehicle occupant restraint device, comprising a wall part (3) of an uncoated fabric and a heat protection device (11) applied onto a section of the wall part (3), the heat protection device (11) being formed from at least one layer of a further uncoated fabric (13) glued to the wall part (3) using a flame-retardant adhesive (15).

2. The gas bag according to claim 1, characterized in that the flame-retardant adhesive (15) comprises a polymer matrix and exfoliated stratified silicate particles distributed in said polymer matrix, the exfoliated stratified silicate particles having a thickness of 0.5 to 2 nm and a surface diameter of up to 10 μm.

3. The gas bag according to claim 2, characterized in that the stratified silicate particles are present in a proportion of 1 to 6 parts by weight per 100 parts by weight of the polymer matrix.

4. The gas bag according to claim 2, characterized in that the stratified silicate particles are rendered hydrophobic using organic onium compounds.

5. The gas bag according to claim 4, characterized in that the organic onium compounds are selected from the group of amino acids and amino acid derivatives.

6. The gas bag according to claim 2, characterized in that the stratified silicate particles are formed from a stratified silicate selected from the group consisting of montmorrilonite, saponite, beidelite, nontronite, sauconite, stevensonite, hectorite, bentonite, vermiculite, halloysite, kaolin, calcium methasilicate, smectite and fluorosmectite.

7. The gas bag according to claim 2, characterized in that the polymer matrix is a composition based on polyurethane.

8. The gas bag according to claim 1, characterized in that at least one of said uncoated fabric of the wall part (3) and said further uncoated fabric consists of polyamide.
